(19) United States
(12) Patent Application Publication
(10) Pub. No.: US 2005/0120354 A1
(43) Pub. Date: Jun. 2, 2005

(54) Information processing system and information processing device

(75) Inventors: Yoji Sunada, Yokohama (JP); Hodaka Furuya, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/793,961

(22) Filed: Mar. 4, 2004

(30) Foreign Application Priority Data
Nov. 19, 2003 (JP) 2003-389929

(51) Int. Cl. G06F 3/00

(52) U.S. Cl. 719/310

(57) ABSTRACT

The load condition of all of the servers participating in a system can be centrally managed. A load information filing function in each of servers (1) through (n) collects basic information such as CPU usage rates, access requests (IOPS) and so on, and saves the information in a local LU. The load information filing function statistically processes the basic information to generate load information. The load information accumulates in a shared LU. The system administrator can display and verify a list of the load information stored in the shared LU on a terminal screen, simply by accessing the load information gathering function of any of the servers via a web browser in a terminal. When any of the servers is in a high load state, because a low load server proxies the load information-related processing of the high load server, the load condition of all of the servers can be centrally managed regardless of load variations in any of the servers.

### CROSS-REFERENCE TO RELATED APPLICATIONS

This application relates to and claims priority from Japanese Patent Application No. 2003-389929 filed on Nov. 19, 2003, the entire disclosure of which is incorporated herein by reference.

### BACKGROUND OF THE INVENTION

1. Field of the Invention

The present invention relates to an information processing system and information processing device.

2. Description of the Related Art

A file server is used for sharing data among a plurality of computer terminals. Early conventional file servers consisted, for example, of a multipurpose OS (Operating System) provided with a CIFS (Common Internet File System), NFS (Network File System: NFS is a trademark of Sun Microsystems U.S.A.), or other file sharing protocol. Conventional improved file servers include NAS that uses an exclusive OS that is specialized for file sharing service in which a number of file sharing protocols (CIFS, NFS, DAFS (Direct Access File System), and the like) are supported.

A cluster system is also established to do such things as to increase the reliability of the information processing system and to perform load distribution and the like. A cluster system is a system in which multiple NAS are interconnected into one cohesive unit. A cluster system consists of at least two NAS. By one NAS sending heartbeat transmissions to the other NAS at fixed intervals, they monitor system failures for each other. A system failure in a NAS is detected from a disruption in the heartbeat transmission. When either of the NAS experiences a system failure, service is turned over to the other NAS. Consequently, by employing this type of redundant structure, the number of NAS constituting the information processing system increases.

Also, JP (Kokai) No. 2003-30011 discloses a technique for, when a fault occurs in one of the nodes in the cluster, storing a memory dump at the time of the occurrence of the fault into a shared disk.

### SUMMARY OF THE INVENTION

It is preferred that the system administrator continually verify the operational status of all NAS that constitute the information processing system. However, the NAS operational status is managed and saved independently for each NAS. Consequently, the time required for the system administrator to manually inspect each NAS and verify its operational status has not been considered. The load of the processing carried out for a NAS that is in a state of overload in order to verify the operational status of the NAS has also not been considered.

An object of the present invention is to provide an information processing system and information processing device wherein the load state of information processing devices can be centrally managed.

Another object of the present invention is to provide an information processing system and information processing device capable of stably and centrally managing the load state of information processing devices even when the load on the information processing device is increased.

The information processing system provided by the present invention comprises an information processing system comprises a plurality of inform ation processing devices and a shared storage device shared by each of the information processing devices. Each of the information processing devices comprise a load information filing unit for generating load information relating to the load state of the each device and storing the load information in a shared storage device; a load information supplying unit for reading the load information stored in the shared storage device for the information processing devices according to a load information access request and supplying the load information to the information processing device which has issued the load information access request; a processing proxy device selecting unit for selecting a processing proxy origin device and a processing proxy destination device from among the plural information processing devices based on the each load information stored in the shared storage device; a proxy processing unit for proxying specific processing in the selected processing proxy origin device when the each device is selected as the processing proxy destination device; and a proxy object processing registration unit for pre-registering specific processing that is to be an object of processing proxying carried out by the selected processing proxy destination device in case where the each device is selected as the processing proxy origin device.

According to an embodiment of the invention, each information processing device comprises a computer device provided with a CPU (Central Processor), memory, and the like. The information processing device can also be provided with file sharing functionality, and may be configured, for example, as a file server or NAS. The shared storage device comprise, for example, a logical storage area (logical volume) installed on a physical storage area provided by a semiconductor storage device, disk storage device, or the like. The information processing devices and shared storage device may be interconnected via a LAN (Local Area Network), the Internet, or another communication network, for example. Also, all or some of the information processing devices may be combined into one or more clusters. Each of the information processing devices is provided with a load information filing unit, a load information supplying unit, a processing proxy device selecting unit, a proxy processing unit, and a proxy object processing registration unit.

According to an embodiment, the load information filing unit generates load information relating to the load state of its own device and stores the load information in a shared storage device. For example, the load information filing unit is capable of collecting basic information relating to the load state, and generating load information by performing further statistical processing of this basic information. Basic information may include, for example, the CPU usage rate, the number of files accessed, the data input/output speed to the storage device, and the like. Statistical processing may include, for example, maximum values, minimum values, average values, and the like. By using statistically processed load information, data sizes can be reduced compared to using the basic information as-is.

According to an embodiment, the load information supplying unit reads load information stored in the shared storage device for the information processing devices according to a load information access request and provides the load information to the information processing device which has issued the load information access request. The device which has issued the load information access request may in this case include, for example, an administration terminal operated by the system administrator. In this manner, the load information from the information processing devices is stored centrally in the shared storage device, and, furthermore, the load information for all of the information processing devices can be accessed via the load information supplying unit possessed by any one of the information processing devices. By this means, the system administrator can verify the load state of all the information processing devices merely by accessing any one of the information processing devices. In this case, the load information supplying unit, for example, may be provided in an embodiment in which the load information can be accessed by a web browser. Web browser-accessible embodiments may include, for example, HTML (HyperText Markup Language), XML (extensible Markup Language), SGML (Standard Generalized Markup Language), and the like. By this means, load information for all the information processing devices can be monitored using an administration terminal outfitted only with a web browser. Such an administration terminal may include, for example, a personal computer, portable information terminal, portable telephone, or the like.

According to an embodiment, the processing proxy device selecting unit selects a processing proxy origin device and a processing proxy destination device from among the information processing devices based on the each load information stored in the shared storage device. At least part of the processing due to be performed by the processing proxy origin device is proxied by the processing proxy destination device. By means of this autonomous load distribution, high load states occurring in some information processing devices can be reduced, resulting in stability of the information processing system.

According to an embodiment, the processing proxy device selecting unit can select the device with the highest load in the plural devices to be the processing proxy origin device, and can select the device with the lowest load in those devices to be the processing proxy destination. When the highest load exceeds a specific maximum value, the processing proxy device selecting unit can select that device as the processing proxy origin information processing device, and when the lowest load falls below a specific minimum value, the processing proxy device selecting unit can select that device as the processing proxy destination information processing device. Furthermore, the processing proxy device selecting unit can also select a processing proxy origin device and a processing proxy destination device at specific time intervals. It should be noted in this case that the processing proxy device selecting unit in each information processing device selects a processing proxy origin device and processing proxy destination device not only with attention to its own device, but autonomously and equally selects a processing proxy origin device and processing proxy destination device for the information processing system as a whole. The processing proxy device selecting unit can select a processing proxy origin device and processing proxy destination device across clusters.

According to an embodiment, the shared storage device stores a proxy relation administration table having data for administering the relationship between the processing proxy origin device and the processing proxy destination device. The processing proxy device selecting unit can also select a processing proxy origin device and a processing proxy destination device based on the load information and the proxy relation administration table.

According to an embodiment, specific processing proxied by the proxy processing unit can be designated as all or part of the processing due to be executed by the load information filing unit. By this means, even when the load on an information processing device is increased, the load state of the processing proxy origin device can be monitored by the processing proxy destination device.

According to an embodiment, the proxy object processing registration unit pre-registers specific processing that to be an object of the processing proxying carried out the selected processing proxy destination device. The processing proxy destination device may only proxy specific processing that is registered in advance. In this case, the proxy object processing registration unit, for example, can register specific processing in a scheduling table in advance. The proxy processing unit of the processing proxy destination device then performs specific processing based on the scheduling table by appropriating the authority to read the scheduling table. The proxy processing unit of the processing proxy destination device can forfeit the authority to read the scheduling table when the selection of the processing proxy destination device is cancelled by the processing proxy device selecting unit.

Further objects of the present invention will become clear in the description of embodiments given hereinafter.

### BRIEF DESCRIPTION OF THE DRAWINGS

FIG. 1 is a block diagram showing a general outline of an information processing system pertaining to an embodiment of the present invention;

FIG. 2 depicts an example of the structure of information filed in a shared LU, wherein (a) is a schematic diagram depicting a case in which information based on a load information administration table is accessed by a web browser, and (b) is a diagram depicting an example of a proxy relation administration table;

FIG. 3 is a diagram depicting the scheduling table before proxying is performed;

FIG. 4 is a diagram depicting the scheduling table in a case in which proxying is performed in midcourse;

FIG. 5 is a diagram depicting the flow of processing from load information generation to filing;

FIG. 6 is a diagram depicting the flow from proxy relation selection to process proxying;

FIG. 7 is a flowchart of the basic information filing process;

FIG. 8 us a flowchart of the load information filing process;

FIG. 9 is a flowchart of the proxy relation selection process for selecting a proxy origin server and proxy destination server;

FIG. 10 is a flowchart of the proxy processing performed by the proxy destination server; and

FIG. 11 is a diagram that schematically depicts the manner in which processing related to load information is proxied.

### DESCRIPTION OF THE PREFERRED EMBODIMENTS

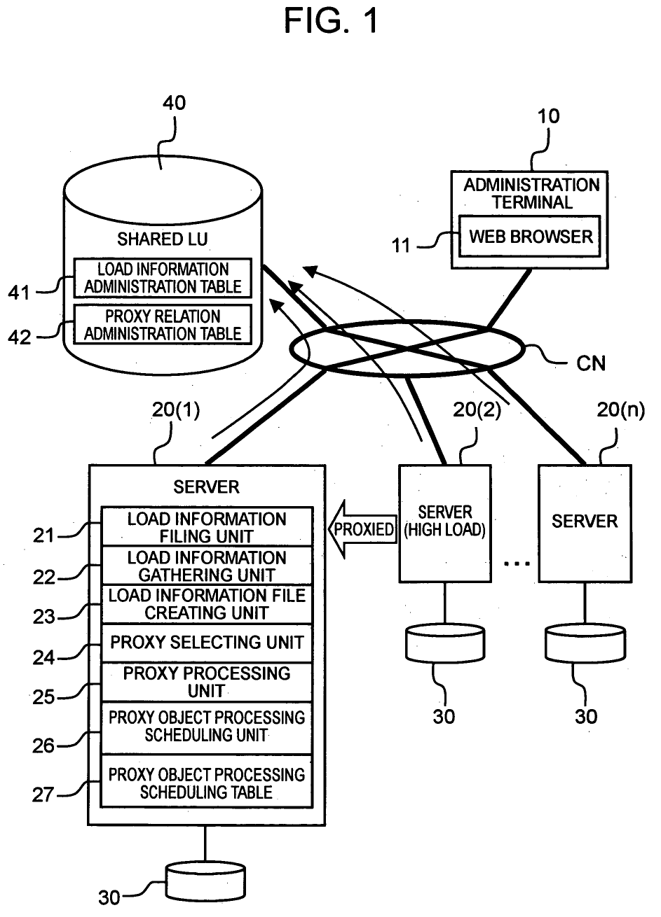

Embodiments of the load information supplying unit will be described hereinafter based on FIGS. 1 through 11.

The information processing system pertaining to the present invention is made up of a plurality of servers, a shared storage device that is shared between the servers, and an administration terminal for administering the servers that are connected so as to be capable of two-way communication via a communication network.

The servers are each provided with a load information filing unit, a load information supplying unit, a processing proxy server selecting unit, a proxy processing unit, and a proxy object processing registration unit. These units terminate and stay resident in the servers in a form such as an agent program, for example.

In this case, about which details will be further described hereinafter, the load information filing unit functions to generate load information by collecting basic information relating to the load state in its own device, to statistically process this basic information, and to store this load information in the shared storage device. The load information supplying unit functions to read the load information stored in the shared storage device for each server and to provide the load information to the administration terminal according to load information access requests from the administration terminal. Also, the processing proxy server selecting unit functions to select the server with the highest load to be the processing proxy origin and to select the server with the lowest load to be the processing proxy destination based on load information stored in the shared storage device at specific time intervals. The proxy processing unit functions to proxy the processing of the load information filing unit of the server selected as the processing proxy origin when its own device is selected as the processing proxy destination. The proxy object processing registration unit functions to pre-register specific processing that requests processing proxying from the server device selected as the processing proxy destination when its own device is selected as the processing proxy origin.

### 1. Embodiment 1

FIG. 1 is a block diagram showing a general outline of the information processing system according to the present embodiment. This information processing system is made up of an administration terminal 10, which corresponds to the “origin at which the load information access request was issued,” a plurality of servers 20(1) through 20(n), which correspond to the “servers” or “information processing devices” (referred to as “servers 20” when not indicating a specific server), and a shared LU (Logical Unit) 40, which corresponds to the “shared storage device,” and each of these components will be described hereinafter. The administration terminal 10, servers 20, and shared LU 40 are interconnected via a LAN, WAN (Wide Area Network), the Internet, or another communication network CN, for example. In this case, data transmissions between the administration terminal 10 and servers 20 follow the TCP/IP (Transmission Control Protocol/Internet Protocol), for example. Also, a configuration in which the shared LU 40 is directly accessible from the administration terminal 10 is not necessary.

The administration terminal 10 consists, for example, of a computer device that is operated by the system administrator of the information processing system. The administration terminal 10 is made up, for example, of a personal computer, workstation, portable information terminal, portable telephone, or other such computer device capable of data transmission. At least a web browser 11 is installed in the administration terminal 10. The web browser 11 is capable of accessing files defined in HTML, XML, SGML, or another markup language, for example.

The servers 20 are connected with local LU 30 via a SAN (Storage Area Network), dedicated communication circuit, or the like, for example. Each local LU 30 consists of logical storage areas (logical volumes) configured on a hard disk device, optical disk device, semiconductor memory device, or other physical storage device, for example. The servers 20 are capable of providing a file sharing service using the local LU 30. Identically configured processors 21 through 26 are installed in the servers 20. These processors 21 through 26 perform their functions by means of prescribed programs being executed therein. All or some of the processors 21 through 26, or portions of the processors, may also be capable of functioning as a hardware circuit.

The load information filing unit 21 functions to store load information. The servers 20 function as the load information filing unit 21 by means of a load information filing program being executed by the servers 20. In more specific detail, the load information filing unit 21 periodically collects and compiles information relating to the load on the server 20 in which it is installed, and stores this information in the prescribed directory of the shared LU 40.

The load information gathering unit 22 functions to gather load information. The servers 20 function as the load information gathering units 22 by means of a load information gathering program being executed by the servers 20. The load information gathering function consists of reading all of the load information stored in the shared LU 40 when an access request is received from the web browser 11 of the administration terminal 10. A load information file creating unit 23 also functions to create load information files. The servers 20 function as the load information file creating unit 23 by means of a load information file creating program being executed by the servers 20. The load information file creating function consists of compiling the load information gathered by the load information gathering unit 22 into a form that is accessible by the web browser 11, and providing the same to the web browser 11. The load information file creating unit 23 is capable of functioning by means of a CGI (Common Gateway Interface) program for automatically creating a webpage being executed on the servers 20. The load information gathering unit 22 and load information file creating unit 23 correspond to the “load information supplying unit.”

The processing proxy server selecting unit 24 (hereinafter referred to as “the proxy selecting unit”) functions to select a processing proxy origin server and processing proxy destination server. The proxy selecting unit 24 corresponds to the “processing proxy file server selecting unit” or “processing proxy device selecting unit.” The servers 20 function as the proxy selecting unit 24 by means of a proxy selecting program being executed on the servers 20. In further detail, the proxy selecting unit 24 functions to select high-load servers 20 to be the processing proxy origin, and low-load servers 20 to be the processing proxy destination, based on the load state of each of the servers 20.

The proxy processing unit 25 executes a processing proxy function, and corresponds to the “proxy processing unit.” The servers 20 function as the proxy processing unit 25 by means of a processing proxy program being executed on the servers 20. The processing proxy function consists of executing specific processing assumed from the processing proxy origin servers 20 when the servers 20 in which the proxy processing unit is installed are selected as the processing proxy destination.

The proxy object processing scheduling unit 26 (hereinafter referred to as “the scheduling unit”) corresponds to the “proxy object processing registration unit” or “proxy object processing registration unit.” The servers 20 function as the scheduling unit 26 by means of a proxy object processing scheduling program being executed on the servers 20. The scheduling unit 26 registers processing that requests proxying from the proxy destination server 20 in advance in the proxy object processing scheduling table 27 (hereinafter referred to as “the scheduling table”). The scheduling unit 26 registers the processing of the load information filing unit 21 as proxy handling (*1) processing in advance in the scheduling table 27. Besides this, some regular business application services (for example, electronic mail services, video reporting services, document management services, and the like) can also be registered in the scheduling table 27 as types of proxy object processing. Usually, the processing that is registered in the scheduling table 27 is executed by its server 20. In high load conditions, the processing that is registered in the scheduling table 27 is executed by the proxy destination server 20.

The shared LU 40 consists, for example, of a logical storage area (logical volume) configured on a hard disk device, optical disk device, semiconductor memory device, or other physical storage device. A load information administration table 41 and a proxy relation administration table 42, for example, are stored in the shared LU 40. Load information from each of the servers 20 is registered in the load information administration table 41. Also, information relating to the proxy origin server 20 and proxy destination server 20 is registered in the proxy relation administration table 42.

Also, the load information administration table 41 does not necessarily exist in a table format. For example, a configuration may be adopted whereby dedicated directories for each of the servers 20 are provided in the shared LU 40, and the load information of each server 20 is stored in its own dedicated directory. Also, the proxy relation administration table 42 is not necessarily needed.

The shared LU 40 and local LU 30 may be disposed in physically separate locations, or may be provided within the same storage subsystem. Specifically, one logical volume set up in the storage subsystem may be used as the shared LU 40, and another several logical volumes may be network-mounted in the servers 20 to act as a local LU 30.

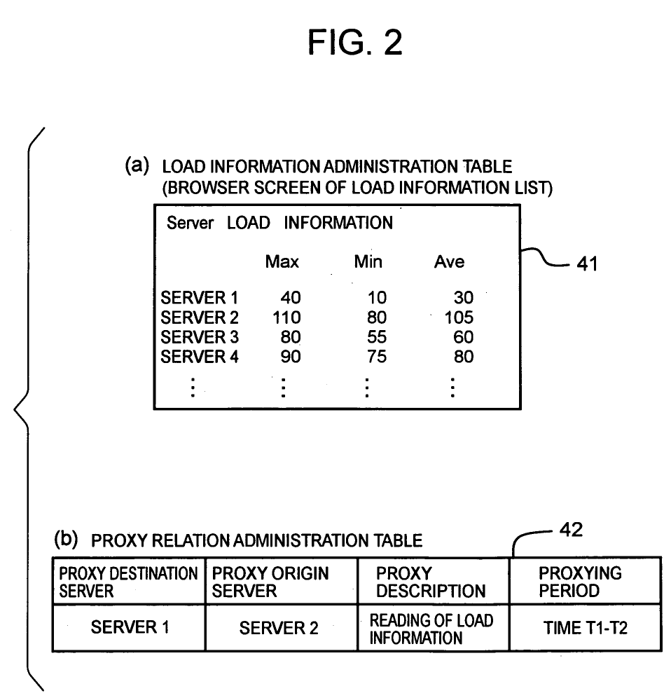

FIG. 2(a) is a schematic diagram depicting the manner in which content stored in the load information administration table 41 is accessed by the web browser 11. The load information of the servers 20 participating in the information processing system is displayed in list format in the web browser 11. The load information is generated by the statistical processing of the CPU usage rate, access counts, and other basic information. Examples of statistical processing methods may include maximum values, minimum values, average values, and the like.

In the example depicted in FIG. 2(a), the load information of the servers 20 is displayed in the form of maximum values, minimum values, and average values. The load information in this case consists of numerical values obtained from statistical processing of basic information, and is adjusted in this embodiment so that a value of 100 is the maximum value during normal operation. Also, “100” is one example, and the present invention is not limited thereby. The load information may also be displayed as a visualization or graphic, such as in a bar graph or the like, for example, and not only as numerical values. Furthermore, the coloration of the graph or numerical values may be changed according to the load level; for example, to red when the load is high, green when the load is normal, and blue when the load is low, or the like.

The proxy relation administration table 42 shown in FIG. 2(b) is for administrating proxy relations within the information processing system. This proxy relation administration table 42 is constituted, for example, by correlating information (for example, an IP address or the like) for specifying the proxy destination server (the server that takes over processing), information for specifying the proxy origin server (the server that requests takeover of processing), descriptions of the processing that is proxied, and the proxy period.

In the figure, the proxy relation for one pair is shown, but proxy relations for a plurality of pairs can also be administrated. Furthermore, proxy relations implemented in the past can also be saved for a prescribed period as a history. By saving a proxy relation history file, this file can then be used to plan maintenance equipment upgrades for the information processing system. Information other than that shown in FIG. 2(b) may also be administrated.

A description of processing that is proxied by the proxy destination server is recorded in the “proxy description” column of the proxy relation administration table 42. In the present embodiment, processing that relates to the load information is proxied. By this means, even when the proxy origin server is in a high load state, the load information of the server in this high load state can be integrated in the shared LU 40 and centrally administrated. The period of proxy processing by the proxy destination server is recorded in the “proxy period” column of the proxy relation administration table 42. In the present embodiment, as will be described hereinafter, revision of the proxy relation is performed according to a prescribed cycle.

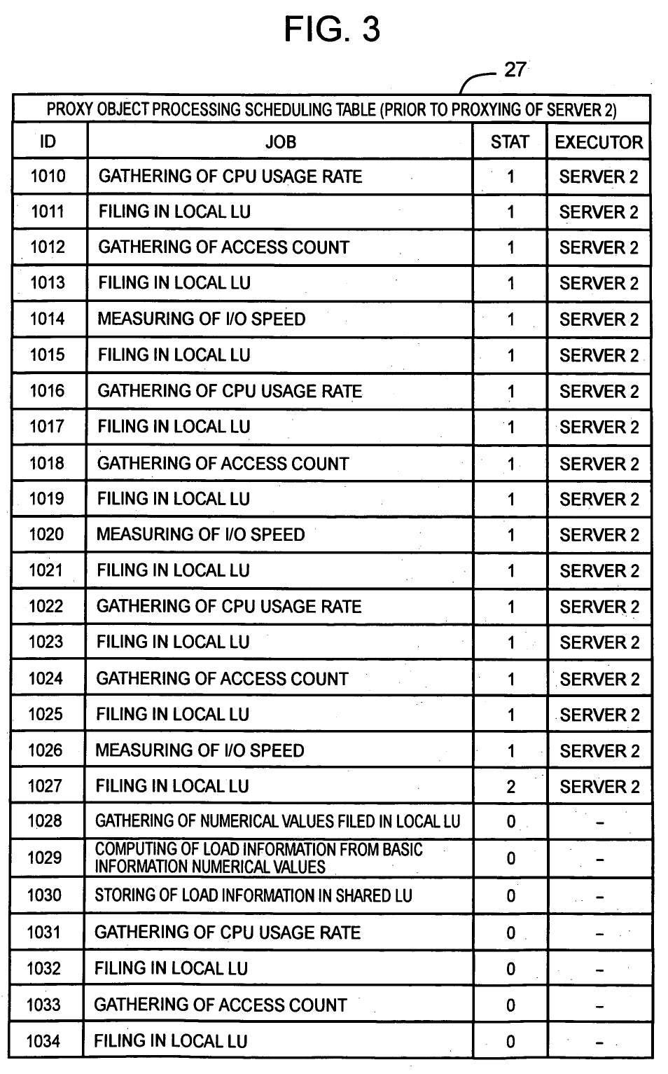

FIG. 3 is a diagram depicting an example of the scheduling table 27. The scheduling table 27 shown in FIG. 3 is registered in the second server 20(2) (displayed as “server 2” in the figure). The following description is of an example in which a high load state occurs in the second server 20(2) that is higher than a prescribed value, and part of the processing of server 20(2) is proxied by the first server 20(1) (“server 1” in the figure). The scheduling table 27 shown in FIG. 3 depicts the state existing before the processing of server 20(2) is proxied.

Process identification numbers (“ID” in the figure) for identifying each process (“JOB” in the figure), descriptions of proxyable processes (“JOB” in the figure), flag information (“STAT” in the figure) for showing the execution status of the processes, and device names (“EXECUTOR” in the figure) in which the processes are executed, for example, are each correlated in the scheduling table 27.

Consecutive numbers, for example, are used in the process identification information (ID). In the example shown in FIG. 3, the scheduling table 27 begins from process No. “1010,” because the table is displayed with a portion thereof missing. Seven types of processes are cited in the present embodiment as proxyable process descriptions (JOB). These seven types of processes can be placed in two general types of process groups. The first type of process performs collection and storage of basic information, and is composed of processes 1 through 4. Process 1 consists of gathering CPU usage rates (process identification Nos. 1010, 1016, and the like). Gathering of CPU usage rates consists of processing for collecting the operation rate of the main processor of the server 20(2). Also, when the server 20(2) is equipped with a plurality of microprocessors, a configuration may be adopted whereby not only the usage rate of the main processor, but also the usage rates of all or some of the other microprocessors are to be gathered. Process 2 consists of gathering access counts (process identification Nos. 1012, 1018, and the like). Gathering of access counts consists of processing for collecting the number of file access requests for the server 20(2). Process 3 consists of measuring the I/O speed (process identification Nos. 1014, 1020, and the like). Measurement of the I/O speed consists of processing for collecting the speed of data input/output processing in response to file access requests. Process 4 consists of filing in the local LU 30 (process identification Nos. 1011, 1013, and the like). Filing in the local LU 30 consists of processing for storing the collected CPU usage rate, access count, and I/O speed in a prescribed area of the local LU 30.

Gathering of the CPU usage rate, gathering of access counts, and measurement of I/O speeds make up the basic information for generating (also referred to hereinafter as “basic information”) the load information. Filing in the local LU 30 is executed whenever these items of basic information are gathered. Gathering the CPU usage rate and filing it in the local LU 30, gathering the access count and filing it in the local LU 30, and measuring the I/O speed and filing it in the local LU 30 each constitute a set of basic information collection and filing processes. These sets of basic information collection and filing processes are performed repeatedly. Cache memory free capacity, network traffic, and other additional information may also be employed as basic information.

Once a certain amount of collection and filing of basic information is performed, the second type of processes are executed. This second type of processes is designed to generate and file load information, and is composed of processes 5 through 7. Process 5 consists of processing for reading (process identification No. 1028) the basic information (CPU usage rate, access count, I/O speed) filed in the local LU 30. Process 6 consists of processing for generating (process identification No. 1029) load information by performing the prescribed statistical processing determined in advance based on the basic information read from the local LU 30. Process 7 consists of processing for filing (process identification No. 1030) the load information thus generated in a prescribed area of the shared LU 40.

According to this arrangement, when several cycles of basic information collection and filing processes are executed and as much basic information as is needed to generate load information is accumulated in the local LU 30, load information generating and filing processes are initiated. When the load information is then filed in the shared LU 40 by means of the load information generation and filing processes, one set of processing is completed. One set of processing consists of the basic information collection and filing processes and load information generating and filing processes. This set of processing is performed repeatedly. It should be noted in this case that the basic information as such is filed in the local LU 30 of the servers 20, and only the load information generated from the basic information is filed in the shared LU 40. By this means, consumption of filing space can be reduced compared to a case in which the basic information consisting of raw data is filed as-is in the shared LU 40, and the processing load exerted by the load information file creating unit 23 when supplying the load information to the web browser 11 can be reduced.

The execution status flag (STAT) shows the execution status of each process, and is configured in the present embodiment so as to be capable of identifying four types of status, for example. For example, an execution status flag that is set to “0” indicates that a process is “unexecuted.” An execution status flag that is set to “1” indicates that a process is “completed.” An execution status flag that is set to “2” indicates that a process is “running from this location (server 20(2) in the example shown in FIG. 3).” An execution status flag that is set to “3” indicates that a process is “running on a proxy destination server.”

The device name, device number, and the like of the server 20 in which the process was executed are recorded in the execution origin device name (EXECUTOR). In the present embodiment, a case is described in which the processing of the server 20(2) is proxied by the server 20(1), so the device names of both servers 20(2) and 20(1) are registered in the execution origin device name.

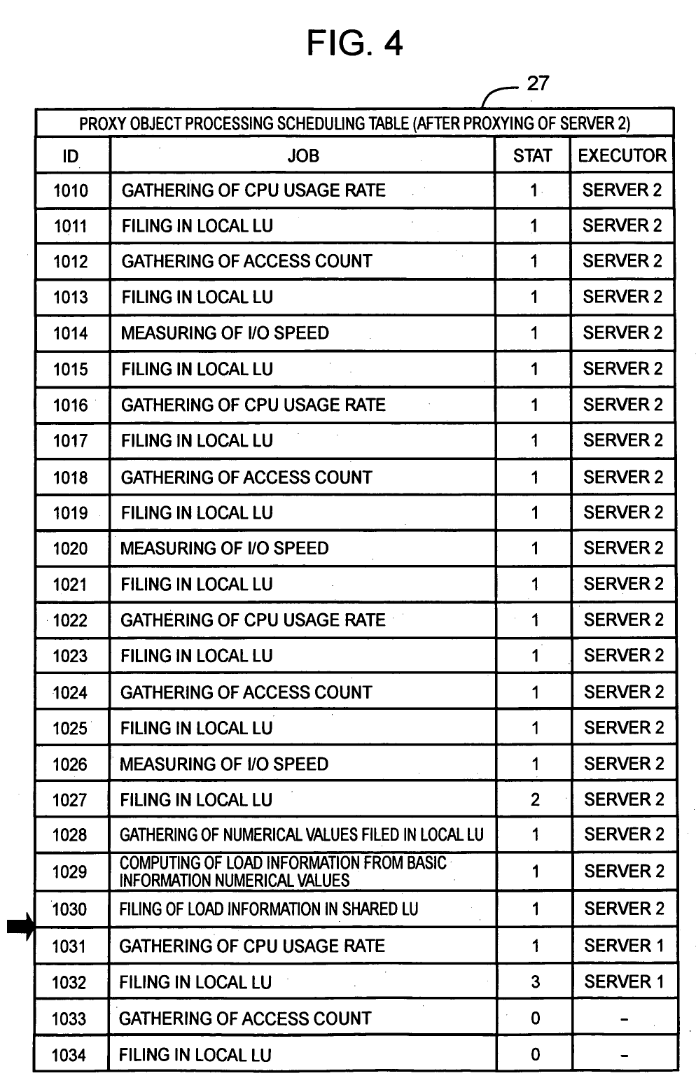

A scheduling table 27 is shown in FIG. 4 for a case in which proxy processing was initiated at a certain point in time. In the example shown in FIG. 4, as indicated by the black arrow in the figure, when execution of process identification No. 1030 was completed, a high load state occurred in server 20(2), and at the time of process identification No. 1031, the processing of server 20(2) was proxied by server 20(1).

Consequently, gathering of the CPU usage rate by process identification No. 1031 is proxied by server 20(i), and the flag is set to (“1”), indicating that execution has finished. A flag is then set to (“3”) for the filing of the subsequent process identification No. 1032 in the local LU 30, indicating that the process is being executed by server 20(1). For the subsequent process identification Nos. 1033 and 1034, flags are set to (“0”), indicating that the processes are not yet executed. In more specific detail, when server 20(1) proxies the processing of server 20(2) registered in the scheduling table 27, the proxy destination server 20(1) acquires the right to access the scheduling table 27. Consequently, server 20(2) becomes unable to read the scheduling table 27 and perform the processing registered therein. When the load on server 20(2) decreases and the proxy relation is cancelled, the right to access the scheduling table 27 reverts from server 20(1) to server 20(2).

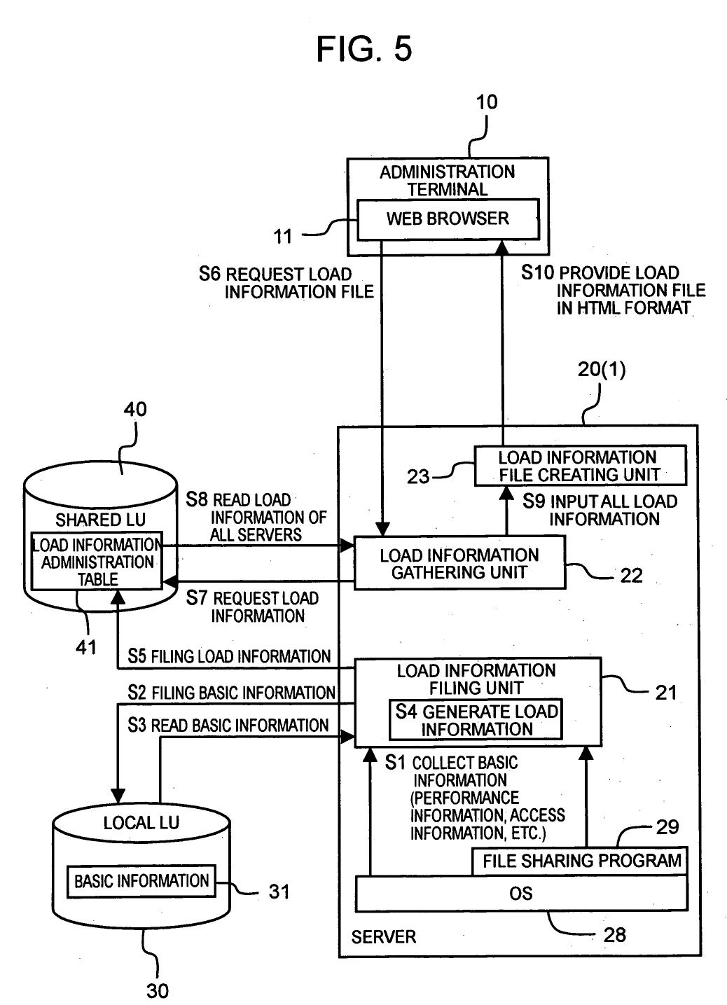

The operation of the present embodiment will next be described. FIG. 5 is a diagram depicting the overall operation from generation of load information to central administration of load information. The description given according to FIG. 5 uses the first server 20(1) as an example, but the operation is the same for any of the servers 20.

Although not pictured in FIG. 1, the servers 20 are provided with an OS 28 and a file sharing program 29. The OS 28 may be configured as a dedicated OS that is specialized as a file sharing service, for example. The file sharing program 29 provides a file sharing service that follows a prescribed file sharing protocol to a client terminal (not pictured).

The load information filing unit 21 periodically collects the CPU usage rate, access count, and other basic information from the OS 28 and file sharing program 29 (S1). Also, although omitted in the diagram, the load information filing unit 21 may also collect basic information from a dedicated input/output processor (I/O processor), memory controller, or other circuit or unit, for example.

The load information filing unit 21 stores the collected basic information in a prescribed area of the local LU 30 (S2). A basic information file 31 is saved in the local LU 30. The load information filing unit 21 reads the basic information from the local LU 30 when a specific quantity of basic information is collected (S3). The load information filing unit 21 generates load information by statistically processing the basic information (S4). The data size of the load information obtained by processing the basic information in this manner is smaller than the total data size of all the basic information used to generate the load information. The load information filing unit 21 stores the generated load information in the shared LU 40 (S5).

The system administrator periodically or continually verifies the load state of each of the servers 20 constituting the information processing system, and works to maintain the system. The system administrator accesses any of the servers 20 (server 20(1) in the example depicted in FIG. 5) at any time via the web browser 11 in the administration terminal 10, and requests transferring of the load information file (S6). Also, the system administrator can perform prescribed authentication by checking user names, passwords, and the like, for example, when logged in to the servers 20 from the administration terminal 10. This authentication may also include checking fingerprints, voiceprints, irises, and other biological information.

The load information gathering unit 22 reads all of the load information accumulated in the shared LU 40 when a transfer request is received from the web browser 11 (S7, S8). The load information gathering unit 22 reads load information relating to all of the servers 20, including those servers 20 other than the server 20(1) that received the transfer request from the web browser 11. The load information relating to all the servers 20 read from the shared LU 40 is turned over from the load information gathering unit 22 to the load information file creating unit 23 (S9).

The load information file creating unit 23 generates a load information file in a form that is accessible by the web browser 11 based on all the inputted load information, and transfers the file to the web browser 11 (S10). Files in a form that is accessible by the web browser 11 may include, for example, HTML, XML, or the like. The list of load information displayed in the web browser 11 is configured in such a manner as is shown in FIG. 2. By this means, the system administrator can verify the load state of all the servers 20 without accessing each of the servers 20 individually.

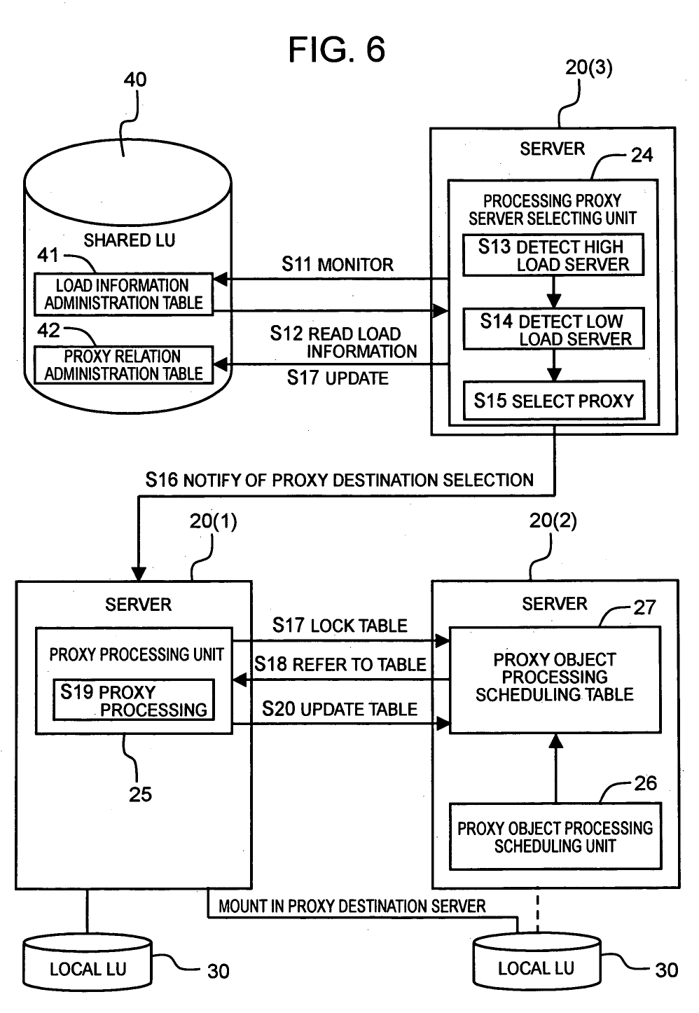

FIG. 6 is a diagram showing the overall operation when the processing of high-load servers 20 is proxied by low-load servers 20. In FIG. 6, the second server 20(2) is in a high load state, and the first server 20(1) is in a low load state. Also, in FIG. 6, a case is depicted in which a third server 20(3) selects a proxy origin server and proxy destination server based on the load state of servers 20(1) and (2). However, the server that selects the proxy relation may also concurrently serve as the proxy origin server or proxy destination server. In the present embodiment, a proxy origin server and proxy destination server are equally selected based on the load information of all the servers 20 participating in the information processing system, so as to achieve the most effective proxy relation for the system as a whole. Consequently, no particular inconvenience arises even if one of the proxy servers selects the proxy relation.

Server 20(3) periodically monitors for the absence of a server 20 in a high load state by accessing the load information administration table 41 of the shared LU 40 (S11, S12). The proxy selecting unit 24 of the server 20(3) detects the server (server 20(2)) that is in a high load state at or above a prescribed maximum value on the basis of an updated description in the load information administration table 41 (S13). The proxy selecting unit 24 also detects the server (server 20(1)) that is in a low load state at or below a prescribed minimum value on the basis of an updated description in the load information administration table 41 (S14). When both the server 20(2) in a high load state that is at or above a prescribed maximum value and the server 20(1) in a low load state that is at or lower than a prescribed minimum value are detected, the proxy selecting unit 24 selects the high load server 20(2) to be the proxy origin server, and selects the low load server 20(1) to be the proxy destination server (S15).

The proxy selecting unit 24 of server 20(3) provides a notification of this selection (proxy destination selection notification) to the server 20(1) selected as the proxy destination server with (S16). This notification can be performed by means of a direct message from server 20(3) to server 20(1), for example. Specifically, a configuration may be adopted whereby a notification of selection travels from server 20(3) to server 20(1) via a prescribed area of the shared LU 40. This proxy destination selection notification contains, for example, information for specifying the proxy destination server 20(1) and information for specifying the proxy origin server 20(2). The server 20(1) selected as the proxy destination partially assumes the processing of the proxy origin server 20(2) based on the proxy destination selection notification from the server 20(3) (S19). Specifically, the proxy processing unit 25 of the proxy destination server 20(1) obtains a read lock for the scheduling table 27 of the proxy origin server 20(2) and makes it so that the proxy origin server 20(2) is unable to refer to its own scheduling table 27 (S17). In this manner, after the table lock is set, the proxy processing unit 25 refers to the scheduling table 27 of the proxy origin server 20(2) (S18) and goes on to execute unprocessed tasks (JOB) in order (S19). The proxy processing unit 25 updates the status flag (STAT) of a self-executing routine (S20). By this means, the execution status flag for the routine executed by the proxy processing unit 25 of server 20(1) changes from “0” to “3” to “1”.

More specifically, when the proxy destination server 20(1) proxies processing according to the scheduling table 27 of the proxy origin server 20(2), the local LU 30 of the proxy origin server 20(2) is unmounted from the proxy origin server 20(2). The local LU 30 of the proxy origin server 20(2) is then mounted to the proxy destination server 20(1). By this means, the proxy destination server 20(1) can assume the processing of the proxy origin server 20(2) using the local LU 30 of the proxy origin server 20(2). The processing that is proxied by the proxy destination server 20(1) consists of processing for collection and filing of basic information, and processing for generation and filing of load information, as described in FIGS. 3 and 4.

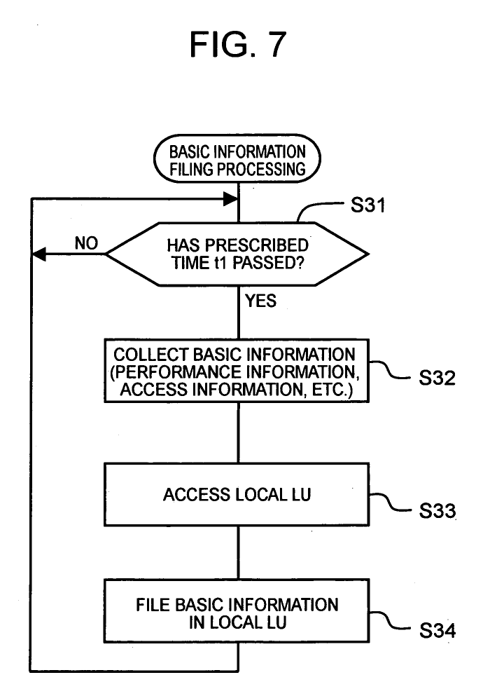

Individual process descriptions will next be described in detail. FIG. 7 depicts the basic information collection and filing processing executed by the load information filing unit 21. Gathering and filing of this basic information in the local LU 30 is executed in all of the servers 20. Also, the processes described hereinafter may also generally be executed in all of the servers 20.

Firstly, the load information filing unit 21 monitors whether or not a specific preset time t1 has passed (S31). This prescribed time t1 is a time that regulates the gathering cycle of the basic information. The prescribed time t1 is set so as not to place a high load on the servers 20, and to enable the required basic information to be collected, for example.

When the prescribed time t1 has passed (S31: YES), the load information filing unit 21 collects the latest basic information on the CPU usage rate, access count, and the like (S32). The load information filing unit 21 accesses the local LU 30 (S33) and stores the latest basic information in a prescribed location of the local LU 30 (S34). The local LU 30 that is accessed by the load information filing unit 21 is the local LU 30 of the server 20 to which the collected basic information corresponds. Specifically, when collection and filing of load information are proxied by the proxy destination server 20, the basic information is stored in the local LU 30 of the proxy origin server 20 rather than in the local LU 30 built into the proxy destination server. Also, for example, the timer that counts off the prescribed time t1 is reset when S34 is resumed.

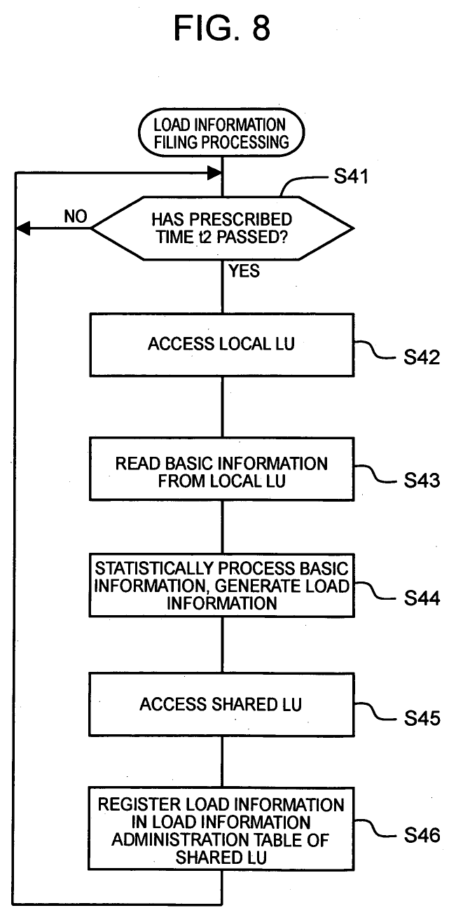

FIG. 8 depicts the load information generation and filing processing executed by the load information filing unit 21. The load information filing unit 21 first monitors whether or not a specific preset time t2 has passed (S41). This prescribed time t2 is a time that regulates the generation file of the load information. The prescribed time t2, similar to the prescribed time t1, is set so as not to place a high load on the servers 20, and so that the load information is collected in the required cycle for management of the information processing system.

When the prescribed time t2 has passed (S41: YES), the load information filing unit 21 accesses the local LU 30 (S42) and reads the basic information stored in the local LU 30 (S43). The load information filing unit 21 generates load information by processing the basic information thus read (S44). Specifically, the load information filing unit 21 generates load values representing the load state of the servers 20 by statistically processing various types and sets of basic information, for example. This statistically processed load information (load values) is generated, for example, as maximum values, minimum values, average values, and the like. The load information filing unit 21 accesses the shared LU 40 (S45) when the load information is generated, and registers the load information in the load information administration table 41 (S46). Also, for example, the timer that counts off the prescribed time t2 is reset when S41 is resumed.

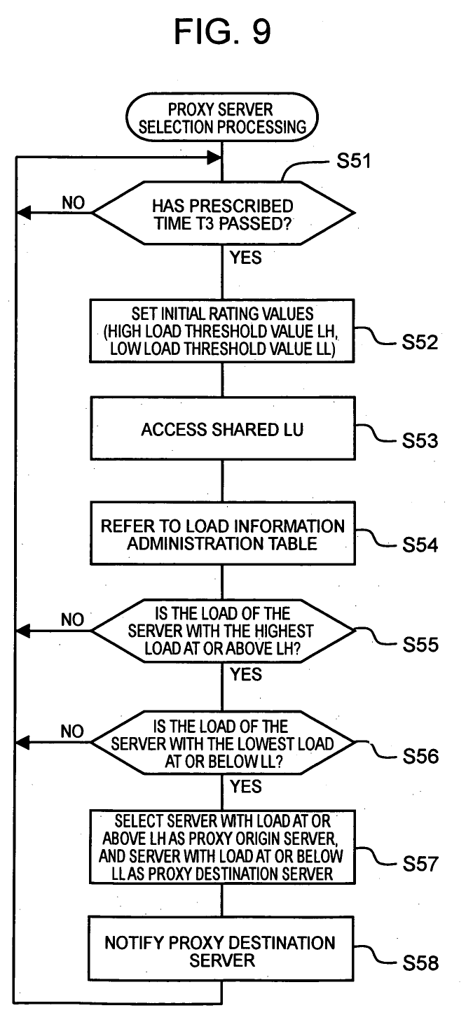

FIG. 9 shows the selection process for the proxy origin server and proxy destination server that is executed by the proxy selecting unit 24. The proxy selecting unit 24 monitors whether or not a specific preset time t3 has passed (S51). This prescribed time t3 is the cycle for selecting the proxy relation, specifically, a time for regulating the cycle in which the proxy relation is reexamined. The prescribed time t3 is set, for example, so as not to place a large load on the servers 20, and so that long periods of proxying are not imposed on the proxy destination server 20. Also, the prescribed times t1 through t3 described above need not consist of fixed values, and may be appropriately adjusted according to the circumstances. The prescribed times t1 through t3 also need not consist of different values.

When the prescribed time t3 has passed (S51:YES), the proxy selecting unit 24 sets initial rating values for selecting the proxy origin server 20 and proxy destination server 20 (S52). The proxy selecting unit 24 sets two types of initial rating values, for example. The first type consists of a high load threshold value LH used for selecting a high load server 20 to be the proxy origin. The other type consists of a low load threshold value LL used for selecting a low load server 20 to be the proxy destination.

The proxy selecting unit 24 accesses the shared LU 53 (*2) (S53) and refers to the load information administration table 41 (S54). The proxy selecting unit 24 detects the server 20 that is in a high load state in the information processing system based on the load information administration table 41, and evaluates whether or not the load of the server 20 in the highest load state is at or above the high load threshold value LH (S55). This high load threshold value LH is set to a load value of “100,” for example.

When the load on the server 20 with the highest load state is less than the high load threshold value LH (S55: NO), the proxy selecting unit 24 determines that the high load state is not sufficient to necessitate proxying of part of the processing, and the system returns to S51. Also, the timer that counts the prescribed time t3 is reset, and time counting is restarted when S51, S55, and S56 are all determined to be “NO,” or when S58 is completed and the system returns to S51.

When the load on the server 20 with the highest load state is at or above the high load threshold value LH (S55: YES), the proxy selecting unit 24 detects the server 20 with the lowest load state in the information processing system on the basis of the load information administration table 41. The proxy selecting unit 24 then determines whether or not the load of the server 20 in the lowest load state is at or below the low load threshold value LL (S56). The low load threshold value LL is set to a load value of “30,” for example. When the load of the server 20 with the lowest load state exceeds the low load threshold value LL (S56: NO), the proxy selecting unit 24 determines that sufficient reserve capacity to proxy the processing of the other servers 20 does not exist, and the system returns to S51.

When the load of the server 20 with the lowest load state is at or below the low load threshold value LL (S56: YES), the proxy selecting unit 24 sets the proxy relation (S57). Specifically, the proxy selecting unit 24 selects the server 20 with the highest load, and that has a load that is at or above the high load threshold value LH, to be the proxy origin server. The proxy selecting unit 24 also selects the server 20 with the lowest load, and that has a load that is at or below the low load threshold value LL, to be the proxy destination server. The proxy selecting unit 24 then provides the server 20 selected as the proxy destination server with information that indicates that the server has been selected as the proxy destination, and with information for specifying the server selected as the proxy origin (S57). As depicted in FIG. 2(a), in the present embodiment, the second server 20(2) has a higher load than any of the other servers 20, and its load average value (Ave) of “105” is above the high load threshold value LH. On the other hand, the first server (1) has a lower load than any of the other servers 20, and its load average value of “30” is equal to the low load threshold value LL. Consequently, the proxy selecting unit 24 selects the second server 20(2) whose load is at or above the high load threshold value LH as the proxy origin server, and selects the first server 20(1) whose load is at or below the low load threshold value LL as the proxy destination server.

It should be noted here that the proxy selecting unit 24 is not merely designed for extracting the server 20 with the highest load and the server 20 with the lowest load to generate a proxying pair. If such as simple pairing were performed, a server 20 whose load value only slightly exceeded that of the other servers 20 could be selected as the proxy origin server, and a server 20 whose load value was only slightly below that of the other servers 20 could be selected as the proxy destination server. When all of the servers 20 are placed in a high load state, as a result of a server 20 with an already high load state being selected as the proxy destination server, the load state of the server 20 selected as the proxy destination would rise further, which could lead to reduced responsiveness or the like. Consequently, optimal load distribution in the information processing system as a whole cannot be performed by a method that involves simple pairing of a high load server 20 with a low load server 20. Therefore, the proxy selecting unit 24 selects the server 20 with the highest load that also is at or above the high load threshold value LH to be the proxy origin server, and selects the server 20 with the lowest load that also is at or below the low load threshold value LL to be the proxy destination server, as described above. By this means, the server 20 that should be proxied is selected as the proxy origin server, and the server 20 that has enough reserve capacity to perform proxying is selected as the proxy destination server. Also, because the load information of all the servers 20 that are candidates for the proxy origin or proxy destination is managed at once in the load information administration table 41, it becomes possible for the server 20 that requires more proxying to be selected as the proxy origin server, and for the server 20 with more reserve capacity for proxying to be selected as the proxy destination server 20.

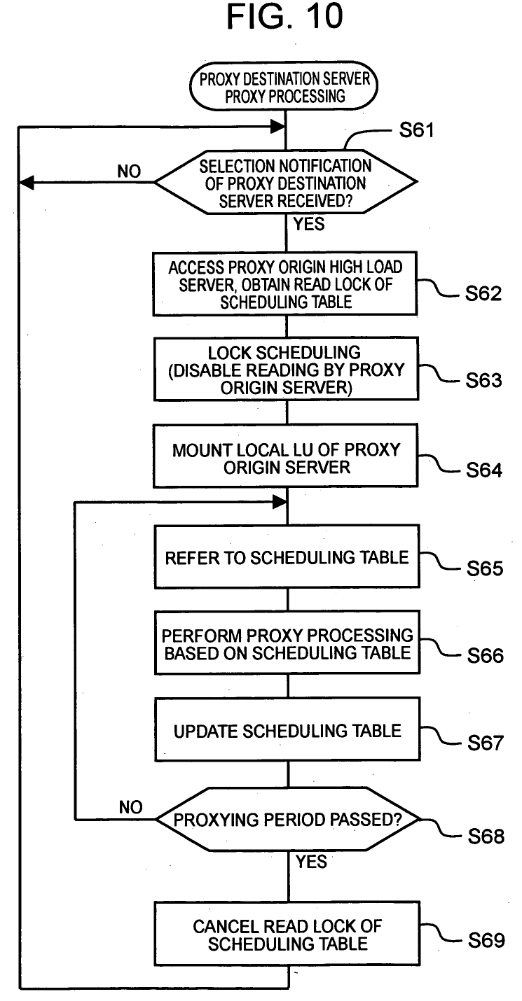

FIG. 10 depicts proxying by the proxy processing unit 25 of the server 20 selected as the proxy destination server. The proxy processing unit 25 is activated when a notification of selection as the proxy destination server is received from the proxy selecting unit 24 (S61: YES). In this case, the proxy selecting unit 24 that notifies the proxy processing unit 25 may be mounted in the same server 20 as the proxy processing unit 25, or may be mounted in a different server 20 from the proxy processing unit 25.

The proxy processing unit 25 accesses the server 20 that is selected as the proxy origin server, and first obtains a read lock for the scheduling table 27 of the proxy origin server (S62). The proxy processing unit 25 of the proxy destination server locks reading of the scheduling table 27 of the proxy origin server (S63). By this means, the proxy origin server becomes unable to read and execute jobs registered in the scheduling table 27. Reading of the scheduling table 27 of the proxy origin server is controlled by the proxy processing unit 25 of the proxy destination server.

The proxy processing unit 25 unmounts the local LU 30 of the proxy origin server from the proxy origin server, and mounts it in the proxy destination server (S64). After the proxy processing unit 25 is placed under the control of the local LU 30 of the proxy origin server, processing is executed (S66) based on the scheduling table 27 of the proxy origin server (S65). When the proxy processing unit 25 executes the processing registered in the scheduling table 27, it rewrites the execution status flag and updates the scheduling table 27 (S67).

The proxy processing unit 25 determines whether or not a preset proxying period has passed (S68). The proxying period may be set according to the revision time of the proxy relation by the proxy selecting unit 24, for example. Until the proxying period has passed; specifically, while the proxy destination server is being designated (S68: NO), the proxy processing unit 25 of the proxy destination server repeats S65 through S67 and executes processing based on the scheduling table 27 of the transition origin server.

When the proxying period has passed (S68: YES), the lock on reading of the scheduling table 27 is cancelled, and the local LU 30 of the proxy origin server is unmounted (S69). The system then returns to S61. In this manner, proxy processing by the proxy processing unit 25 is cancelled every time a specific preset proxying period has passed. When a different server 20 is selected as the proxy destination server by the proxy selecting unit 24, part of the processing of the proxy origin server is proxied by the proxy processing unit 25 of the new server 20. Of course, both the proxy origin server and the proxy destination server may sometimes substitute for other servers 20, and a proxying pair may sometimes not be set, depending on revision of the proxy relation.

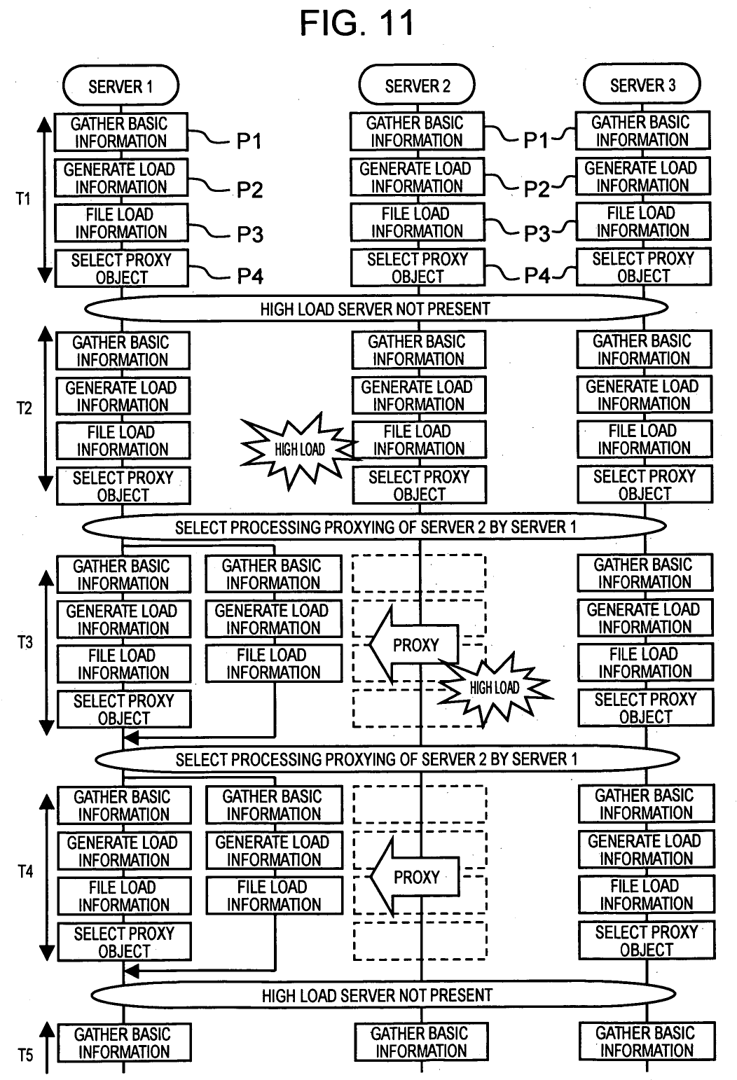

FIG. 11 is a diagram in block format that depicts the manner in which processing is proxied between servers according to the present embodiment. In FIG. 11, an example is described using servers 20(1) (shown as server 1) through (3) (shown as server 3). T1 through T5 shown on the left edge of the figure indicate unit periods of proxying.

During unit periods T1 through T5, servers 20(1) through 20(3) each independently execute collection of basic information (P1), generation of load information based on the basic information (P2), filing of the load information in the shared LU 40 (P3), and selection of a proxy origin server and proxy destination server (P4). Collection of basic information (P1), generation of load information (P2), and filing of load information (P3) are executed by the load information filing unit 21. Selection of proxy objects (also referred to as selection of proxy relations) (P4) is executed by the proxy selecting Unit 24.

During proxying period T1, a high load in the servers 20 has not yet occurred. Consequently, in the proxy relation selection processing P4 executed at the end of proxying period T1, neither the proxy origin server nor the proxy destination server are selected.

The system thus moves into proxying period T2. In proxying period T2, a high load state occurs in the second server 20(2). For example, in such a case as when file access requests from a client terminal are concentrated on the second server 20(2), the load on the second server 20(2) increases. On the other hand, the load on the first server 20(1) is at or below the low load threshold value LL, for example. Therefore, in the proxy relation selection processing performed at the end of proxying period T2 (or, in reverse, the proxy relation selection processing executed just before the beginning of proxying period T3), the server 20(2) is selected as the proxy origin server, and the server 20(1) is selected as the proxy destination server.

In proxying period T3, the load information filing unit 21 or the like of the server 20(1) performs “collection of basic information (P1)” through “filing of load information (P3)” relating to its own device. The proxy processing unit 25 of the server 20(1) also performs processes P1 through P3 relating to the proxy origin server 20(2). Consequently, the load information filing unit 21 of the server 20(1) selected as the proxy destination server individually collects basic information relating to its own device and to the proxy origin server (P1), individually generates load information (P2), and stores the load information in the shared LU 40 (P3). Also, it is not necessary to redundantly execute selection of the proxy relation (P4) for the proxy origin server and the proxy destination server. Consequently, only the proxy selecting unit 24 of the proxy destination server 20(1) and the proxy selecting unit 24 of the server 20(3), which is unrelated to the proxying, select the proxy relation in the next proxying period T4.

By having specific processing relating to the load information of the server 20(2) be selected to and executed by the server 20(1), the load of the server 20(2) is reduced by a corresponding amount. The load information of the server 20(2) in a high load state is also generated by the server 20(1) and stored in the shared LU 40. Consequently, the administrator can confirm the load information of all the servers 20 at once, including the load information relating to the server 20(2) in a high load state, by referring to the load information via the web browser 11.

In proxying period T4, the load of the server 20(2) has decreased below the high load threshold value LH, for example. The proxy relation in proxying period T4 has been selected at the end of proxying period T3. Consequently, during proxying period T4, even if the load of the server 20(2) decreases, proxying of the server 20(2) by the server 20(1) is not cancelled. Also, during the preset proxying period, when the load state increases or decreases, the proxy relation already set may be cancelled, and a new proxy relation may be set.

At the end of proxying period T4, the proxy relation is revised. At this time, because the load of the server 20(2) is decreased below the high load threshold value LH, a proxy relation is not set. Consequently, in proxying period T5, as in proxying period T1, the servers 20(1) through (3) each executes collection of basic information relating to its own device (P1), generation of load information (P2), filing of load information (P3), and selection of proxy relation (P4).

By means of the present embodiment as described above, the following effects are demonstrated.

Firstly, the load information of the servers 20 is integrated in the shared LU 40. The system administrator can easily confirm the load state of all the servers 20 simply by accessing the load information gathering unit 22 of any one of the servers 20 via the web browser 11. Consequently, the system administrator can centrally manage the operational status of each server 20, and maintenance operability is enhanced.

Also, when any of the servers 20 is in a high load state, processing relating to the load information of the high load server 20 is proxied by a low load server 20. Consequently, when a high load state occurs in any of the servers 20, generation and storage of load information relating to the server 20 in a high load state is continued without interruption. Because of this, central management of the load state of the servers 20 can be continued regardless of load fluctuations.

Furthermore, the load information filing unit 21 first collects basic information and stores it in the local LU 30, and generates load information by statistically processing the basic information stored in the local LU 30. Consequently, the data size can be reduced in comparison to a case in which the basic information in the form of raw data is filed as-is in the shared LU 40. A list screen of load information displayed in the web browser 11 can also be easily generated, because the load information, which consists of processed data, is stored in advance in the shared LU 40.

Also, a list of load information can be accessed by means of the web browser 11. Consequently, the administration terminal 10 for centrally verifying the load state may be provided at least with a web browser 11 alone, and need not be equipped with a special accessing unit.

Furthermore, the server 20 with the highest load is selected as the proxy origin server when it has a load that is at or above the high load threshold value LH, and the server 20 with the lowest load is selected as the proxy destination server when it has a load that is at or below the low load threshold value LL. Consequently, the server 20 that requires processing to be taken over can be selected as the proxy origin server, and the server 20 that has enough extra capacity to assume processing can be selected as the proxy destination server.

Also, the proxy selecting unit 24 selects a proxy origin server and proxy destination server based on load information of all the servers 20. Consequently, the proxy relation can be selected equally, and equal load distribution can be performed, based on the condition of the system as a whole.

Furthermore, the proxy selecting unit 24 is configured such that the proxy relation is revised every time a proxying period passes. Consequently, proxy processing can be performed at every prescribed cycle, and central monitoring of load information and responses to load variations can be performed according to a simple control structure.

Also, the present embodiment can be implemented within a file overcluster, or across clusters. Specifically, when a proxy origin server and a proxy destination server constitute a single cluster, specific processing relating to load information is proxied independently, regardless of whether or not the proxy origin server experiences a system failure and a file overload is set in motion. Proxying of specific processing relating to load information is also executed when the proxy origin server and proxy destination server each belong to separate clusters.

Also, the present invention is in no way limited by the embodiment described above. Various additions, modifications, and the like may also be performed by one skilled in the art within the range of the present invention.

For example, in FIG. 11, the operation of the servers 20 is depicted as being substantially synchronous, but in actuality, the servers 20 each operate independently. In this case, the proxy selecting unit 24 in each of the servers 20 can dispense with unnecessary selection by referring to the proxy relation administration table 42 during selection of proxy relations. Specifically, when a proxy relation has already been selected by the proxy selecting unit 24 of one of the servers 20, the proxy selecting unit 24 of another server 20 that is activated directly after this selection can ascertain that proxy relation selection is unnecessary by referring to the proxy relation administration table 42.

Also, in the processing depicted in FIG. 9, the server with the highest load is selected as the proxy origin server when it has a load that is at or above the high load threshold value LH, and the server with the lowest load is selected as the proxy destination server when it has a load that is at or below the low load threshold value LL (S55 through S57), but the present invention is not limited to this arrangement. For example, S55 may be based on the principle that “When it is determined whether a server exists that is at or above the high load threshold value LH, and a server exists whose load is at or above the high load threshold value LH, this server is selected as the proxy origin server. When more than one server has a load that is at or above the high load threshold value LH, the server with the higher load is selected as the proxy origin server.” Also, S56 may be based on the principle that “When it is determined whether a server exists that is at or below the low load threshold value LL, and a server exists whose load is at or below the low load threshold value LL, this server is selected as the proxy destination server. When more than one server has a load that is at or below the low load threshold value LL, the server with the lower load is selected as the proxy destination server.”

1. An information processing system comprising:
a plurality of information processing devices;
a shared storage device that is shared by each of the information processing devices; and
an administration terminal for administering the respective information processing devices;
wherein the each information processing device comprises:
a load information filing unit for collecting basic information relating to the load state of the each information processing device, generating load information by statistically processing the basic information, and storing the load information in the shared storage device;
a load information supplying unit for reading the load information stored in the shared storage device for the plurality of information processing devices according to a load information access request, and supplying the load information to the administration terminal;
a processing proxy information processing device selecting unit for selecting the information processing device with the highest load in the plurality of information processing devices as a processing proxy origin device, and selecting the information processing device with the lowest load in the plurality of information processing devices as the processing proxy destination, based on the load information stored in the shared storage device, at every prescribed period;
a proxy processing unit for proxying the processing of the load information filing unit of the information processing device selected as the processing proxy origin device when the each information processing device is selected as the processing proxy destination device; and
a proxy object processing registration unit for pre-registering the processing of the load information filing unit that is to be an object of proxy processing carried out by the information processing device selected as the processing proxy destination device in case where the each information processing device is selected as the processing proxy origin device.

2. An information processing system comprising:
a plurality of information processing devices; and
a shared storage device that is shared by each of the information processing devices;
wherein the plurality of information processing devices are connected via a communication network so as to be capable of two-way communication and with the shared storage device; and
wherein the each information processing device comprises:
a load information filing unit for generating load information relating to the load state of the each information processing device, and storing the load information in the shared storage device;
a load information supplying unit for reading the load information stored in the shared storage device for the plurality of information processing devices according to a load information access request, and supplying the load information to the information processing device which has issued the load information access request;
a processing proxy device selecting unit for selecting a processing proxy origin device and a processing proxy destination device from among the plurality of information processing devices based on the load information stored in the shared storage device;
a proxy processing unit for proxying specific processing for the information processing device in the case where the each information processing device is selected as the processing proxy destination device; and
a proxy object processing registration unit for pre-registering specific processing that is to be an object of proxy processing carried out by the proxy destination device in case where the each information processing device is selected as the processing proxy origin device.

3. The information processing system according to claim 2, wherein the load information filing unit collects basic information relating to the load state of the each information processing device, generates the load information by statistically processing the basic information, and stores the load information in the shared storage device.

4. The information processing system according to claim 3, wherein the load information supplying unit provides the load information in a form that is accessible by a web browser.

5. The information processing system according to claim 4, wherein the processing proxy device selecting unit selects the information processing device with the highest load in the plurality of information processing devices as the processing proxy origin device, and selects the information processing device with the lowest load in the plurality of information processing devices as the processing proxy destination device, based on the load information stored in the shared storage device.

6. The information processing system according to claim 5, wherein the processing proxy device selecting unit selects the information processing device with the highest load to be the processing proxy origin device on condition that the highest load is above a prescribed maximum value, and selects the information processing device with the lowest load to be the processing proxy destination device on condition that the lowest load is at or below a prescribed minimum value.

7. The information processing system according to claim 6, wherein the processing proxy device selecting unit tries to selects the processing proxy origin device and the processing proxy destination device at every prescribed period.

8. The information processing system according to claim 7, wherein the shared storage device stores a proxy relation administration table having data for administering the proxy relation between the processing proxy origin device and the processing proxy destination device, and the processing proxy device selecting unit selects the processing proxy origin device and the processing proxy destination device based on the each load information and the proxy relation administration table.

9. The information processing system according to claim 8, wherein the specific processing includes all or a part of the processing due to be executed by the load information filing unit.

10. The information processing system according to claim 9, wherein the proxy object processing registration unit pre-registers the specific processing in a scheduling table; and
the proxy processing unit of the processing proxy origin device executes the specific processing based on the scheduling table by appropriating the authority to read the scheduling table, and forfeits the authority to read the scheduling table when the selection of the each information processing device as the processing proxy destination device is cancelled by the processing proxy device selecting unit.

11. A method of operation carried out each of a plurality of information processing devices, which are connected via a communication network so as to be capable of two-way communication with each other and connected with a shared storage device that is shared among the plurality of information processing devices, the method comprising the steps of:
(a) generating load information relating to a load state of each of the plurality of information processing devices and storing the load information to store in the shared storage device;
(b) referring to the load information stored in the shared storage device;
(c) selecting a processing proxy origin device from among the plurality of information processing devices based on the load information;
(d) selecting a processing proxy destination device from among the plurality of information processing devices based on the each load information; and
(e) at the processing proxy destination device, proxying specific processing for the processing proxy origin device.

12. The method according to claim 11, wherein the step (a) includes the steps of collecting basic information relating to the load state of each of the plurality of information processing devices, generating the load information by statistically processing the basic information, and storing the load information in the shared storage device.

13. The method according to claim 11, wherein the step (c) includes the step of (f) selecting the information processing device with the highest load in the plurality of information processing devices as the processing proxy origin device.

14. The method according to claim 13, wherein the step (f) includes the step of selecting the information processing device with the highest load in the plurality of information processing devices as the processing proxy origin device on condition that the highest load is above a prescribed maximum value.

15. The method according to claim 11, wherein the step (c) includes the step of selecting the processing proxy origin device based on the each load information and a proxy relation administration table, the proxy relation administration table having data for administering the proxy relation between the processing proxy origin device and the processing proxy destination device.

16. The method according to claim 11, wherein the specific processing in the step (e) includes all or a part of processing due to be executed by the processing proxy origin.
